(19) United States
(12) Patent Application Publication
(10) Pub. No.: US 2007/0078226 A1
(43) Pub. Date: Apr. 5, 2007

(54) Use of copolymers as auxiliary agents for producing leather

(75) Inventors: Tanja Schneider, Bensheim (DE); Stephan Huffer, Ludwigshafen (DE); Pia Baum, Weinheim (DE); Matthias Kluglein, Ludwigshafen (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 10/556,718

(22) PCT Filed: May 6, 2004
(86) PCT No.: PCT/EP04/04814

§ 371 Date: Nov. 14, 2005

(30) Foreign Application Priority Data
May 13, 2003 (DE) 103 21 628.6

(51) Int. Cl. C08F 297/02

(52) U.S. Cl. 525/242

(57) ABSTRACT

Graft copolymers which contain at least one monoethylenically unsaturated monomer comprising at least one nitrogen-containing heterocycle are used as assistants for leather production.

The present invention relates to the use of graft copolymers which contain at least one monoethylenically unsaturated monomer which is incorporated in the form of polymerized units, containing at least one nitrogen-containing heterocycle, as assistants for leather production.

For the production of leather, polymers may be used in the pretanning, main tanning and retanning. By using polymers in the pretanning, it is possible in many cases completely or at least partly to dispense with chromium compounds. The choice of the polymer can influence the properties of the leather end product. Various proposals are made in the literature regarding the choice of the polymers.

WO 93/17130 discloses that certain maleimide copolymers can be used, for example, in retanning.

However, the polymers mentioned in the prior art are in many cases not optimum for the production of leather. For example, the leathers produced by the methods to date can be improved in their body, their grain characteristics and the surface properties. Furthermore, the distribution of the fats used in retanning in the leather cross section is not optimum. Finally, the color strength achieved in retanning can also be further improved in some cases.

Accordingly, the assistants defined at the outset and intended for leather production were found.

In an embodiment of the present invention, graft copolymers used in the novel assistants for leather production, which are also referred to below as graft copolymers used according to the invention, contain at least one monoethylenically unsaturated monomer, selected from B1 and B2, which is incorporated in the form of polymerized units and contains at least one nitrogen-containing heterocycle.

In an embodiment of the present invention, graft copolymers used in the novel assistants for leather production, which are also referred to below as graft copolymers used according to the invention, contain at least two different monoethylenically unsaturated monomers B1 and B2 which are incorporated in the form of polymerized units and in each case contain at least one nitrogen-containing heterocycle. Particularly preferably, the graft copolymers used according to the invention contain at least one monomer B1 and at least one monomer B2 incorporated in the form of polymerized units.

In an embodiment of the present invention, the copolymers used according to the invention contain, as monomer B1, at least one cyclic amide of the formula I 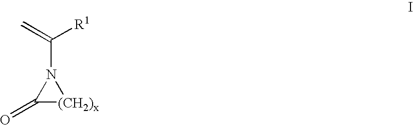
incorporated in the form of polymerized units, where, in formula I,
x is an integer from 1 to 6 and
R¹ is hydrogen or C₁-C₄-alkyl, such as methyl, ethyl, n-propyl, isopropyl, n-butyl, isobutyl, sec-butyl and tert-butyl.

Specific examples of monomers B1 incorporated in the form of polymerized units are N-vinylpyrrolidone, N-vinyl-δ-valerolactam and N-vinyl-ε-caprolactam, N-vinylpyrrolidone being preferred.

In an embodiment of the present invention, the copolymers used according to the invention contain at least one monomer B2 which is incorporated in the form of polymerized units and contains a nitrogen-containing heterocycle selected from the group consisting of the pyrroles, pyrolidines, pyridines, quinolines, isoquinolines, purines, pyrazoles, imidazoles, triazoles, tetrazoles, indolizines, pyridazines, pyrimidines, pyrazines, indoles, isoindoles, oxazoles, oxazolidones, oxazolidines, morpholines, piperazines, piperidines, isoxazoles, thiazoles, isothiazoles, indoxyls, isatins, dioxindoles and hydantoins and derivatives thereof, e.g. barbituric acid and uracil and derivatives thereof.

Preferred heterocycles are imidazoles, pyridines and pyridine N-oxides, imidazoles being particularly preferred.

Examples of particularly suitable comonomers B2 are N-vinylimidazoles, alkylvinylimidazoles, in particular methylvinylimidazoles, such as 1-vinyl-2-methylimidazole, 3-vinylimidazole N-oxide, 2- and 4-vinylpyridines, 2- and 4-vinylpyridine N-oxides and betaine derivatives and quaternization products of these monomers.

Very particularly preferred comonomers B2 incorporated in the form of polymerized units are N-vinylimidazoles of the formula II a, betaine N-vinylimidazoles of the formula II b, 2- and 4-vinylpyridines of the formulae II c and II d and betaine 2- and 4-vinylpyridines of the formulae II e and II f 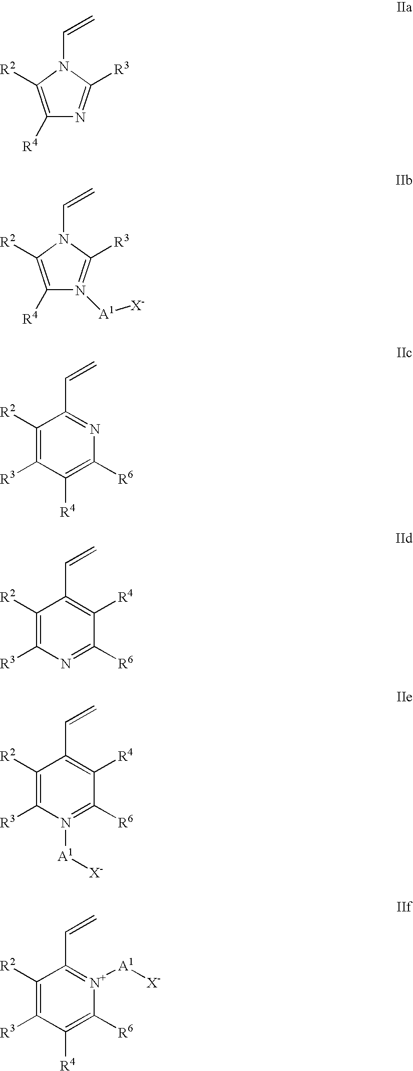
where
R², R³, R⁴ and R⁶, independently of one another, are hydrogen, C₁-C₄-alkyl, such as methyl, ethyl, n-propyl, isopropyl, n-butyl, isobutyl, sec-butyl and tert-butyl, or phenyl, preferably hydrogen;
A¹ is C₁-C₂₀-alkylene, for example —CH₂—, —CH(CH₃)—, —(CH₂)₂—, —CH₂—CH(CH₃)—, —(CH₂)₃—, —(CH₂)₄—, —(CH₂)₅— or —(CH₂)₆—, preferably C₁-C₃-alkylene, in particular —CH₂—, —(CH₂)₂— or —(CH₂)₃—;
X⁻ is —SO₃⁻, —OSO₃⁻, —COO⁻, —OPO(OH)O⁻, —OPO(OR⁵)O⁻ or —PO(OH)O⁻;
R⁵ is C₁-C₂₄-alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, n-nonyl, or n-decyl, particularly preferably C₁-C₄-alkyl, such as methyl, ethyl, n-propyl, isopropyl, n-butyl, isobutyl, sec-butyl and tert-butyl.

Examples of particularly preferred betaine monomers B2 incorporated in the form of polymerized units are monomers of the formulae II b, II e and II f in which the group A¹-X⁻ is —CH₂—COO⁻, —(CH₂)₂—SO₃⁻ or —(CH₂)₃—SO₃— and the remaining variables are each hydrogen.

Vinylimidazoles and vinylpyridines are also suitable as monomers B2 incorporated in the form of polymerized units, which monomers have been quaternized before or after the polymerization.

The quaternization can be carried out in particular using alkylating agents, such as alkyl halides, which as a rule have 1 to 24 carbon atoms in the alkyl radical, or dialkyl sulfates, which generally contain alkyl radicals of 1 to 10 carbon atoms. Examples of suitable alkylating agents from these groups are methyl chloride, methyl bromide, methyl iodide, ethyl chloride, ethyl bromide, propyl chloride, hexyl chloride, dodecyl chloride and lauryl chloride and dimethyl sulfate and diethyl sulfate. Further suitable alkylating agents are, for example, benzyl halides, in particular benzyl chloride and benzyl bromide; chloroacetic acid; methyl fluorosulfate; diazomethane; oxonium compounds, such as trimethyloxonium tetrafluoroborate; alkylene oxides, such as ethylene oxide, propylene oxide and glycidol, which are used in the presence of acids; cationic epichlorohydrins. Preferred quaternizing agents are methyl chloride, dimethyl sulfate and diethyl sulfate.

Examples of particularly suitable quaternized monomers B2 incorporated in the form of polymerized units are 1-methyl-3-vinylimidazolium methosulfate and methochloride.

The weight ratio of the monomers B1 or B2 or monomers B1 and B2 and, if required, B3 which are incorporated in the form of polymerized units is as a rule from 99:1 to 1:99, preferably from 90:10 to 30:70, particularly preferably from 90:1 to 50:50, very particularly preferably from 80:20 to 50:50, in particular from 80:20 to 60:40.

The copolymers used according to the invention may contain one or more further monomers B3 incorporated in the form of polymerized units, for example carboxyl-containing monoethylenically unsaturated monomers, such as unsaturated C₂-C₁₀-mono- or dicarboxylic acids and derivatives thereof, such as salts, esters, amides and anhydrides. The following may be mentioned by way of example:

acids and their salts, such as (meth)acrylic acid, fumaric acid, maleic acid and the respective alkali metal or ammonium salts; anhydrides, such as maleic anhydride; esters, such as methyl (meth)acrylate, ethyl (meth)acrylate, n-butyl (meth)acrylate, dimethyl maleate, diethyl maleate, dimethyl fumarate, diethyl fumarate or di-n-butyl fumarate;

further examples of B3 are vinyl acetate and vinyl propionate and ethylenically unsaturated compounds of the formulae III a to III d, 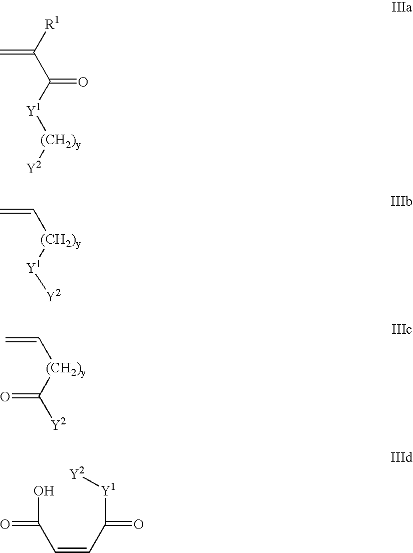
the formulae being defined as follows:
R¹ is as defined above,
Y¹ is selected from oxygen and NH,
y is an integer selected from 1 and 0,
Y² is [A²-O]ₛ-[A³-O]ᵤ—-A⁴-O]ᵥ—R⁸
A² to A⁴ are identical or different and, independently of one another, are —(CH₂)₂—, —(CH₂)₃—, —(CH₂)₄—, —CH₂—CH(CH₃)—, —CH₂—CH(CH₂—CH₃)— or —CH₂—CHOR¹⁰ —CH₂—;
R⁸ is hydrogen, amino-C₁-C₆-alkyl, where the amino group may be a primary, secondary or tertiary amino group, for example CH₂—NH₂, —(CH₂)₂—NH₂, —CH₂—CH(CH₃)—NH₂, —CH₂—NHCH₃, —CH₂—N(CH₃)₂, —N(CH₃)₂, —NHCH₃ or, —N(C₂H₅)₂, C₁-C₂₄-alkyl, R⁹—CO— or R⁹—NH—CO—;
R⁹ is C₁-C₂₄-alkyl,
R¹⁰ is hydrogen, C₁-C₂₄-alkyl or R⁹—CO—,
s is an integer from 0 to 500;
u are identical or different and in each case are integers from 1 to 5 000,
v are identical or different and in each case are integers from 0 to 5 000, and
w are identical or different and in each case are integers from 0 to 5 000.

C₁ -C₂₄-Alkyl radicals in formulae III a to III d may be branched or straight-chain C₁-C₂₄-alkyl radicals, C₁-C₁₂-alkyl radicals being preferred and C₁-C₆-alkyl radicals being particularly preferred. Examples are methyl, ethyl, n-propyl, 1-methylethyl, n-butyl, 1-methylpropyl, 2-methylpropyl, 1,1-dimethylethyl, n-pentyl, 1-methylbutyl, 2-methylbutyl, 3-mrethylbutyl, 2,2-dimethylpropyl, 1-ethylpropyl, n-hexyl, 1,1-dimethylpropyl, 1,2-dimethylpropyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl, 1-ethyl-2-methylpropyl, n-heptyl, 2-ethylhexyl, n-octyl, n-nonyl, n-decyl, n-undecyl, n-dodecyl, n-tridecyl, n-tetradecyl, n-pentadecyl, n-hexadecyl, n-heptadecyl, n-octadecyl, n-nonadecyl and n-eicosyl.

In an embodiment, graft copolymers which are composed of a polymeric grafting base A which has no monoethylenically unsaturated units, and polymeric side chains B formed from copolymers of at least one monoethylenically unsaturated monomer selected from B1 or B2 or monomers B1 and B2 and, if required, B3, which contains at least one nitrogen-containing heterocycle, and optionally further comonomers B3 are used.

In an embodiment, graft copolymers which are composed of a polymeric grafting base A which has no monoethylenically unsaturated units, and polymeric side chains B formed from copolymers of at least two monoethylenically unsaturated monomers B1 or B2 or monomers B1 and B2 and, if required, B3, which in each case contain at least one nitrogen-containing heterocycle, and optionally further comonomers B3 are used.

The graft copolymers which are used in that embodiment of the novel process which is described below and which may have a comb-like structure can be characterized by their ratio of side chains B to polymeric grafting base A. The proportion of the side chains B in the graft copolymers is advantageously greater than 35% by weight, based on the total graft copolymer. Preferably, the proportion is from 55 to 95, particularly preferably from 70 to 90, % by weight.

The side chains B of the graft copolymer contain, as monomer B1, preferably at least one cyclic amide of the formula I 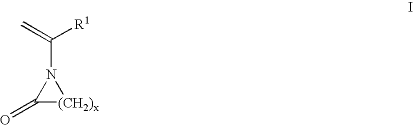
incorporated in the form of polymerized units, the variables in formula I being as defined above.

Specific examples of monomers B1 incorporated in the form of polymerized units are N-vinylpyrrolidone, N-vinyl-δ-valerolactam and N-vinyl-ε-caprolactam, N-vinylpyrrolidone being preferred.

In an embodiment of the present invention, the side chains B preferably contain at least one monoethylenically unsaturated monomer B2 which is incorporated in the form of polymerized units and contains a nitrogen-containing heterocycle selected from the group consisting of the pyrroles, pyrrolidines, pyridines, quinolines, isoquinolines, purines, pyrazoles, imidazoles, triazoles, tetrazoles, indolizines, pyridazines, pyrimidines, pyrazines, indoles, isoindoles, oxazoles, oxazolidones, oxazolidines, morpholines, piperazines, piperidines, isoxazoles, thiazoles, isothiazoles, indoxyls, isatins, dioxindoles and hydantoins and derivatives thereof, e.g. barbituric acid and. uracil and derivatives thereof.

Preferred heterocycles are imidazoles, pyridines and pyridine N-oxides, imidazoles being particularly preferred.

Examples of particularly suitable comonomers B2 are N-vinylimidazole, alkylvinylimidazoles, in particular methylvinylimidazoles, such as 1-vinyl-2-methylimidazole, 3-vinylimidazole N-oxide, 2- and 4-vinylpyridines, 2- and 4-vinylpyridine N-oxides and betaine derivatives and quaternization products of these monomers.

Very particularly preferred comonomers B2 incorporated in the form of polymerized units are N-vinylimidazole of the formula II a, betaine N-vinylimidazoles of the formula II b, 2- and 4-vinylpyridines of the formulae II c and II d and betaine 2- and 4-vinylpyridines of the formulae II e and II f.

Examples of very particularly preferred betaine monomers B2 incorporated in the form of polymerized units are monomers of the formulae II b, II e and II f in which the group A¹-X⁻ is —CH₂—COO⁻, —(CH₂)₂—SO₃⁻ or —(CH₂)₃—SO₃⁻ and the remaining variables are each hydrogen.

Vinylimidazoles and vinylpyridines are also suitable as monomers B2 which are incorporated in the form of polymerized units and have been quaternized before or after the polymerization.

The quaternization can be carried out in particular as described above.

Examples of particularly suitable quaternized monomers B2 incorporated in the form of polymerized units are 1-methyl-3-vinylimidazolium methosulfate and methochloride.

The weight ratio of monomers B1 or B2 or monomers B1 and B2 and, if required, B3 which are incorporated in the form of polymerized units is as a rule from 99:1 to 1:99, preferably from 90:10 to 30:70, particularly preferably from 90:10 to 50:50, very particularly preferably from 80:20 to 50:50, in particular from 80:20 to 60:40.

The graft copolymers used according to the invention may contain one or more further monomers B3 incorporated in the form of polymerized units in the side chains, e.g. carboxyl-containing monoethylenically unsaturated monomers, for example unsaturated C₂-C₁₀-mono- or dicarboxylic acids and derivatives thereof, such as salts, esters, anhydrides, which are defined as above.

The polymeric grafting base A of the graft copolymers used according to the invention is preferably a polyether. The term polymer is also intended to include oligomeric compounds.

Particularly preferred polymeric grafting bases A have an average molecular weight Mₙ of at least 300 g.

Particularly preferred polymeric grafting bases A are of the formula IV a 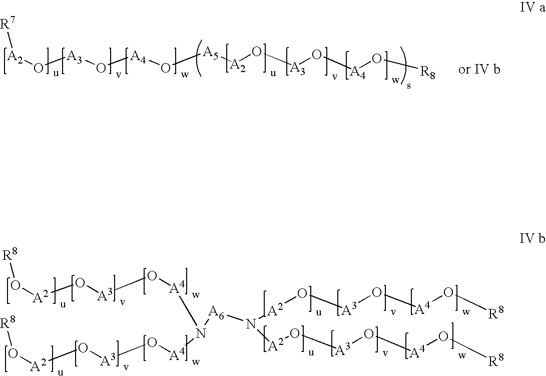
where
R⁷ is hydroxyl, amino, C₁-C₂₄-alkoxy, such as methoxy, ethoxy, n-propoxy, isopropoxy, n-butoxy, isobutoxy, sec-butoxy, tert-butoxy, n-pentyloxy, isopentyloxy, n-hexyloxy or isohexyloxy, R⁹—COO—, R⁹—NH—COO— or a polyalcohol radical, such as glyceryl;
A² to A⁴ are identical or different and are each —(CH₂)₂—, —(CH₂)₃—, —(CH₂)₄—, —CH₂—CH(CH₃)—, —CH₂—CH(CH₂—CH₃)— or —CH₂—CHOR¹⁰—CH₂—;
R⁸ is hydrogen, amino-C₁-C₆-alkyl, it being possible for the amino group to be a primary, secondary or tertiary amino group, for example —CH₂—NH₂, —(CH₂)₂—NH₂, 13 CH₂—CH(CH₃)—NH₂, —CH₂—NHCH₃, —CH₂—N(CH₃)₂, —N(CH₃)₂, —NHCH₃ or —N(C₂H₅)₂;
   C₁ -C₂₄-alkyl;
   R⁹—CO—, R⁹—NH—CO—;
A⁵ is —CO—O—, —CO—B—CO—O— or —CO—NH—B—NH—CO—O—;
A⁶ is C₁-C₂₀-alkylene whose carbon chain may be interrupted by 1 to 10 oxygen atoms as ether functions;
B is —(CH₂)ₜ—, arylene, for example para-phenylene, meta-phenylene, ortho-phenylene, 1,8-naphthylene or 2,7-naphthylene, substituted or unsubstituted;
n is 1 or, if R⁷ is a polyalcohol radical, is from 1 to 8;
t is an integer from 1 to 12;

and the other variables are as defined above.

Polymeric grafting bases A of the formula IV a are preferably polyethers from the group consisting of the polyalkylene oxides based on ethylene oxide, propylene oxide and butylene oxides, polytetrahydrofuran and polyglycerol. Depending on the type of monomer building blocks, polymers having the following structural units result:
—(CH₂)₂—O—, —(CH₂)₃—O—, —(CH₂)₄—O—, —CH₂—CH(CH₃)—O—, —CH₂—CH(CH₂—CH₃)—O—, —CH₂—CHOR⁸ —CH₂—O—

Both homopolymers and copolymers are suitable as the grafting base, it being possible for the copolymers to be random copolymers or block copolymers.

The terminal primary hydroxyl groups of the polyethers prepared on the basis of alkylene oxides or glycerol and the secondary OH groups of polyglycerol may be present in free form or etherified with C₁-C₂₄-alcohols, esterified with C₁-C₂₄-carboxylic acids or reacted with isocyanates to give urethanes. Alcohols suitable for this purpose are, for example, primary aliphatic alcohols, such as methanol, ethanol, propanol and butanol, primary aromatic alcohols, such as phenol, isopropylphenol, tert-butylphenol, octylphenol, nonylphenol and naphthol, secondary aliphatic alcohols, such as isopropanol, tertiary aliphatic alcohols, such as tert-butanol, and polyhydric alcohols, e.g. diols, such as ethylene glycol, diethylene glycol, propylene glycol, 1,3-propanediol and butanediol, and triols, such as glycerol and trimethylolpropane. However, the hydroxyl groups may also be exchanged for primary amino groups by reductive amination with hydrogen ammonia mixtures under superatmospheric pressure or may be converted into aminopropylene terminal groups by cyanoethylation with acrylonitrile and hydrogenation. Not only can the conversion of the terminal hydroxyl groups be carried out subsequently by reaction with alcohols or with alkali metal hydroxide solutions, amines and hydroxylamines, but these compounds can also be used, in the same manner as Lewis acids, e.g. boron trifluoride, as initiators at the beginning of the polymerization. Finally, the terminal hydroxyl groups can also be etherified by reaction with alkylating agents, such as dimethyl sulfate.

The C₁-C₂₄-alkyl radicals in formulae IV a and IV b may be branched or straight-chain C₁-C₂₄-alkyl radicals, C₁-C₁₂-alkyl radicals being preferred and C₁-C₆-alkyl radicals being particularly preferred. Examples are methyl, ethyl, n-propyl, 1-methylethyl, n-butyl, 1-methylpropyl, 2-methylpropyl, 1,1-dimethylethyl, n-pentyl, 1-methylbutyl, 2-methylbutyl, 3-methylbutyl, 2,2-dimethylpropyl, 1-ethylpropyl, n-hexyl, 1,1-dimethylpropyl, 1,2-dimethylpropyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-i-methylpropyl, 1-ethyl-2-methylpropyl, n-heptyl, 2-ethylhexyl, n-octyl, n-nonyl, n-decyl, n-undecyl, n-dodecyl, n-tridecyl, n-tetradecyl, n-pentadecyl, n-hexadecyl, n-heptadecyl, n-octadecyl, n-nonadecyl and n-eicosyl.

The average molecular weight Mₙ of the polyethers of the formula IV a is at least 300 g/mol and is as a rule ≦100 000 g/mol. It is preferably from 500 to 50 000, particularly preferably up to 10 000, very particularly preferably up to 2 000, g/mol. The polydispersity of the polyethers of the formula IV a is in most cases low, for example from 1.1 to 1.8.

Homo- and copolymers of ethylene oxide, propylene oxide, butylene oxide and isobutylene oxide, which may be linear or branched, can be used as polymeric grafting base A. In the context of the present invention, the term homopolymer also includes those polymers which, in addition to the polymerized alkylene oxide unit, also contain the reactive molecules which were used for initiating the polymerization of the cyclic ethers or for end group blocking of the polymer.

Branched polymers can be prepared, for example, by subjecting, for example, pentaerythritol, glycerol and sugars or sugar alcohols, such as sucrose, D-sorbitol and D-mannitol, disaccharides, ethylene oxide and, if desired, propylene oxide and/or butylene oxides or polyglycerol to an addition reaction with low molecular weight polyalcohols (R⁷ in formulae IV a and IV b).

Polymers in which at least one, preferably from one to eight, particularly preferably from one to five, of the hydroxyl groups present in the polyalcohol molecule can be linked in the form of an ether bond to the polyether radical according to formula IV a or IV b may be formed.

Four-armed polymers can be obtained by subjecting the alkylene oxides to an addition reaction with diamines, preferably ethylenediamine.

Further branched polymers can be prepared by reacting alkylene oxides with amines having a higher functionality, e.g. triamines, or in particular polyethylenimines. The polyethylenimines suitable for this purpose have, as a rule, average molecular weights Mₙ of from 300 to 20 000 g, preferably from 500 to 10 000 g, particularly preferably from 500 to 5 000 g. The weight ratio of alkylene oxide to polyethylenimine is usually from 100:1 to 0.1:1, preferably from 20:1 to 0.5:1.

It is also possible to use polyesters of polyalkylene oxides and aliphatic C₁-C₁₂-dicarboxylic acids, preferably C₁-C₆-dicarboxylic acids, or aromatic dicarboxylic acids, e.g. oxalic acid, succinic acid, adipic acid or terephthalic acid, having average molecular weights Mₙ of from 1 500 to 25 000 g/mol, as polymeric grafting base A.

It is furthermore possible, instead of IV a and IV b, to use polycarbonates of polyalkylene oxides, which polycarbonates have been prepared by phosgenation, or polyurethanes of polyalkylene oxides and aliphatic C₁-C₁₂-diisocyanates, preferably C₁-C₆-diisocyanates, or aromatic diisocyanates, e.g. hexamethylene diisocyanate or phenylene diisocyanate, as polymeric grafting base A.

These polyesters, polycarbonates or polyurethanes may contain up to 500, preferably up to 100, polyalkylene oxide units, it being possible for the polyalkylene oxide units to consist both of homopolymers and of copolymers of different alkylene oxides.

Homo- and copolymers of ethylene oxide and/or propylene oxide, which may be blocked at one or both terminal groups, are particularly preferably used as polymeric grafting base A.

An effect of polypropylene oxide and copolymeric alkylene oxides having a high propylene oxide content is that the grafting is easily carried out.

An effect of polyethylene oxide and copolymeric alkylene oxides having a high ethylene oxide content is that, when grafting is complete and where the grafting density is the same as in the case of the polypropylene oxide, the weight ratio of side chain to polymeric grafting base is greater.

The K values of the graft copolymers are usually from 10 to 150, preferably from 10 to 80, particularly preferably from 15 to 60 (determined according to H. Fikentscher, Cellulose-Chemie 13 (1932), 58 to 64 and 71 to 74, in water or 3% by weight aqueous sodium chloride solutions at 25° C. and polymer concentrations which, depending on the K value range, are from 0.1 to 5% by weight). The K value desired in each case can be established by the composition of the starting materials. At 100% theoretical degree of grafting, the molecular weight of the products is given by the molecular weight of the grafting base and the amount of comonomers which react as side chains. The more molecules used as grafting base, the more terminal molecules are present, and vice versa. The side chain density can be established by the amount of initiator and the reaction conditions.

In a further process for the preparation of the graft copolymers used according to the invention, the monomers B1 and/or B2 and, if required, further comonomers B3 are subjected to free radical polymerization in the presence of the polymeric grafting base A.

The polymerization can be carried out, for example, in the manner of a solution polymerization, mass polymerization, emulsion polymerization, inverse emulsion polymerization, suspension polymerization, inverse suspension polymerization or precipitation polymerization. Mass polymerization and especially solution polymerization, which is carried out in particular in the presence of water, are preferred.

In the mass polymerization, monomer B1 or B2 or the monomers B1 and B2 and, if required, B3 can be dissolved in the polymeric grafting base A, the mixture heated to the polymerization temperature and polymerized after addition of a free radical initiator. The polymerization can also be carried out semicontinuously by initially taking a part, for example 10% by weight, of the mixture of polymeric grafting base A, monomer B1 or B2 or monomers B1 and B2 and, if required, B3 and free radical initiator and heating them to the polymerization temperature and, after initiation of the polymerization, adding the remainder of the mixture to be polymerized, according to the progress of the polymerization. However, it is also possible initially to take the polymeric grafting base A in a reactor, to heat it to the polymerization temperature, to add monomers B1 or B2 or monomers B1 and B2 and, if required, B3 (separately or as a mixture) and the free radical initiator, either all at once, batchwise or preferably continuously, and to carry out polymerization. The graft copolymerization described above can be carried out in one or more solvents. Suitable organic solvents are, for example, aliphatic and cycloaliphatic monohydric alcohols, such as methanol, ethanol, n-propanol, isopropanol, n-butanol, sec-butanol, tert-butanol, n-hexanol and cyclohexanol, polyhydric alcohols, e.g. glycols, such as ethylene glycol, propylene glycol and butylene glycol, and glycerol, alkyl ethers of polyhydric alcohols, e.g. methyl and ethyl ethers of said dihydric alcohols, and ether alcohols, such as diethylene glycol and triethylene glycol, and cyclic ethers, such as dioxane.

The graft copolymerization is preferably carried out in water as a solvent. Here, A, B1 and/or B2 and, if required, further comonomers B3 are more or less readily dissolved depending on the amount of water used. Some or all of the water may also be added in the course of the polymerization. Of course, mixtures of water and the abovementioned organic solvents may also be used.

Usually, from 5 to 250, preferably from 10 to 150, % by weight, based on the graft copolymer, of organic solvent, water or mixture of water and organic solvent are used. In the polymerization in water, as a rule from 10 to 70, preferably from 20 to 50, % by weight of solutions or dispersions of the novel graft copolymers are obtained, which solutions or dispersions can be converted into powder form with the aid of various drying methods, e.g. spray drying, fluidized spray drying, drum drying or freeze drying.

By introduction into water, an aqueous solution or dispersion can then readily be prepared again at the desired time.

Particularly suitable free radical initiators are peroxo compounds, azo compounds, redox initiator systems and reducing compounds. Of course, mixtures of free radical initiators may also be used.

Specific examples of suitable free radical initiators are: alkali metal peroxodisulfates, e.g. sodium peroxodisulfate, ammonium peroxodisulfate, hydrogen peroxide, organic peroxides, such as diacetyl peroxide, di-tert-butyl peroxide, diamyl peroxide, dioctanoyl peroxide, didecanoyl peroxide, dilauryl peroxide, dibenzoyl peroxide, bis(o-tolyl) peroxide, succinyl peroxide, tert-butyl peracetate, tert-butyl permaleate, tert-butyl perisobutyrate, tert-butyl perpivalate, tert-butyl peroctanoate, tert-butyl perneodecanoate, tert-butyl perbenzoate, tert-butyl peroxide, tert-butyl hydroperoxide, cumyl hydroperoxide, tert-butyl peroxy-2-ethylhexanoate and diisopropyl peroxydicarbamate; azobisisobutyronitrile, azobis(2-amidopropane) dihydrochloride and 2,2′-azobis(2-methylbutyronitrile); sodium sulfite, sodium bisulfite, sodium formaldehyde sulfoxylate and hydrazine and combinations of the abovementioned compounds with hydrogen peroxide; ascorbic acid/iron(II) sulfate/Na₂S₂O₈, tert-butyl hydroperoxide/sodium disulfite and tert-butyl hydroperoxide/sodium hydroxymethanesulfonate.

Preferred free radical initiators are, for example, tert-butyl perpivalate, tert-butyl peroctanoate, tert-butyl perneodecanoate, tert-butyl peroxide, tert-butyl hydroperoxide, azobis(2-methylpropionamidine) dihydrochloride, 2,2′-azobis(2-methylbutyronitrile), hydrogen peroxide and sodium peroxodisulfate, the redox metal salts of which, e.g. iron salts, can be added in small amounts.

Usually, from 0.01 to 10, preferably from 0.1 to 5, % by weight, based on monomers B1 or B2 or monomers B1 and B2 and, if required, B3, of free radical initiators are usually used.

If desired, polymerization regulators may also be used. The compounds known to a person skilled in the art, for example sulfur compounds, such as mercaptoethanol, 2-ethylhexyl thioglycolate, thioglycolic acid and dodecyl mercaptan, but also other regulator types, for example bisulfite and hypophosphite, are suitable. If polymerization regulators are used, the amount thereof which is used is as a rule from 0.1 to 15, preferably from 0.1 to 5, particularly preferably from 0.1 to 2.5, % by weight, based on monomers B1 or B2 or monomers B1 and B2 and, if required, B3.

The polymerization temperature is as a rule from 30 to 200° C., preferably from 50 to 150° C., particularly preferably from 75 to 110° C.

The polymerization is usually carried out under atmospheric pressure but can also take place under reduced or superatmospheric pressure, e.g. at from 0.5 to 5 bar.

According to the invention, the graft copolymers described above can be used as assistants in leather production. Particularly preferably, the graft copolymers described above are used in retanning.

The present invention furthermore relates to leather assistants comprising the graft copolymers described above. Leather assistants according to the invention which may be used are aqueous dispersions which contain at least one of the graft copolymers described above, usually in a concentration of from 1 to 60, preferably from 10 to 50, % by weight. Further components of the novel leather assistants may be, for example, fatliquoring agents, emulsifiers, inorganic fillers, tanning agents, in particular resin tanning agents, sulfone tanning agents or vegetable tanning agents.

The present invention relates to a process for the production of leather using a novel leather assistant and hence using the graft copolymers described above. Embodiments of the novel process are tanning processes, in particular retanning processes, also referred to below as novel retanning processes.

The novel retanning process starts from hides of animals, for example cattle, pigs, goats or deer, which have been pretreated by methods known per se, i.e. the pelts. It is not important for the novel retanning process whether, for example, the animals were slaughtered or died of natural causes. The conventional pretreatment methods include, for example, liming, deliming, bating and pickling and mechanical preparations, for example fleshing of the hides.

In addition, the hides pretreated as described above are treated with tanning substances known to a person skilled in the art before the beginning of the novel retanning process, for example with chrome tanning agents, with mineral tanning agents, such as aluminum compounds or titanium compounds, with polymer tanning agents, with syntans or with vegetable tanning agents.

The novel retanning process is carried out in general in such a way that one or more novel tanning agents are added in one portion or in a plurality of portions immediately before or during the retanning. The novel retanning process is preferably carried out at a pH of from 4 to 6, it being observed that the pH can decrease by about 0.3 to three units while the novel retanning process is being carried out. The pH can be reduced by about 0.3 to three units by adding acidifying agents.

The novel retanning process is carried out in general at from 5 to 60° C., preferably from 20 to 50° C. A duration of, for example, from 10 minutes to 12 hours, preferably from one to three hours, has proven useful. The novel retanning process can be carried out in any desired vessels customary in tanning, for example by tumbling in barrels or in rotating drums.

In an embodiment of the novel retanning process, the graft copolymers described above are added together with one or more conventional tanning agents, for example with chrome tanning agents, mineral tanning agents, aldehydes, syntans, resin tanning agents, polymer tanning agents or vegetable tanning agents, as described, for example, in Ullmann's Encyclopedia of Industrial Chemistry, Volume A15, pages 259 to 282 and in particular page 268 et seq., 5th Edition (1990), Verlag Chemie Weinheim. The weight ratio of graft copolymer described above to conventional tanning agent or sum of the conventional tanning agents is expediently from 0.01:1 to 100:1. In an advantageous variant of the novel process, only a few ppm of the conventional tanning agent are added to the graft copolymers described above. However, it is particularly advantageous completely to dispense with the admixture of conventional tanning agents.

Said graft copolymers are usually used in the form of aqueous solutions or aqueous dispersions in amounts of from 0.5 to 60, preferably from 1 to 10, % by weight, based on the shaved weight, of the solid.

In a variant of the novel retanning process, graft copolymers described above are added in one portion or in a plurality of portions.

In an embodiment of the present invention, leather dyes known per se to a person skilled in the art are added in amounts customary in tanning for carrying out the novel retanning process.

In an embodiment of the present invention, detergents and/or wetting agents known per se to a person skilled in the art are added in amounts customary in tanning for carrying out the novel retanning process.

In an embodiment of the present invention, compositions known per se to a person skilled in the art are used in amounts customary in tanning for carrying out the novel retanning process, for example fatliquors, acrylate- and/or methacrylate-based fatliquoring agents, retanning agents based on resin tanning agents and vegetable tanning agents, fillers, leather dyes and emulsifiers.

The novel retanning process can be carried out under otherwise conventional conditions. Expediently, one or more, for example from 2 to 6, treatment steps are chosen and washing with water can be effected between the treatment steps.

A further aspect of the present invention relates to leathers produced using the novel assistants for leather production. The leathers produced according to the invention contain the graft copolymers described above. The novel leathers have an overall advantageous quality, for example they are particularly tight-grained. Moreover, they exhibit a particularly good leveling and color-deepening effect, which leads to particularly brilliantly colored leathers. The novel leathers contain the graft copolymers described above particularly uniformly distributed over the cross section.

A further aspect of the present invention is the use of the novel leathers for the production of articles of clothing, furniture or automotive parts. In the context of the present invention, articles of clothing are, for example, jackets, shoes, gloves, pants, belts or suspenders. In association with the present invention, furniture comprises all furniture which contains leather components. Examples are seating furniture, such as seats, chairs and sofas. Examples of automotive parts are automobile seats.

A further aspect of the present invention relates to articles of clothing comprising the novel leathers or produced from novel leathers. A further aspect of the present invention relates to furniture comprising the novel leathers or produced from novel leathers. A further aspect of the present invention relates to automotive parts comprising the novel leathers or produced from novel leathers.

The working examples which follow illustrate the invention.

### EXAMPLES

### 1. Synthesis of Graft Copolymers Used According to the Invention

1.1. Synthesis of graft copolymer 1 (P1)

In a reactor having a nitrogen feed, reflux condenser, stirrer and metering apparatus, 10 g of polyethylene glycol having an average molecular weight M_{w} of 600 g/mol (Pluriol®E, BASF Aktiengesellschaft) and 56.2 g of water were heated to an internal temperature of about 85° C. while feeding in nitrogen. A mixture of 27.5 g of N-vinylpyrrolidone and 12.5 g of N-vinylimidazole was then added continuously in the course of 3¼ hours. Simultaneously with this mixture, 0.8 g of 2,2′-azobis(2-methylpropionamidine) dihydrochloride (V50®, from Wako Chemicals) was added continuously in the course of 3¼ hours. After the end of the addition, cooling was effected to 60° C. After this temperature had been reached, 0.3 g of tert-butyl hydroperoxide in 1.72 ml of water was added. 0.2 g of Na₂S₂O₅ in 6.26 ml of water was then added. A clear, slightly yellow polymer solution was obtained. The solids content was 42% by weight.

The K value was determined according to H. Fikentscher, Cellulose-Chemie 13, 58-64 and 71-74, at 25° C. in 3% by weight aqueous NaCI solution and was 40.

1.2. Synthesis of Graft Copolymer 2 (P2

In a reactor having a nitrogen feed, reflux condenser, stirrer and metering apparatus, 120 g of polyethylene glycol having an average molecular weight Mₙ of 9 000 g/mol and 120 g of water were heated to an internal temperature of about 80° C. while feeding in nitrogen. The addition of a mixture of 280 g of N-vinylpyrrolidone and 2.8 g of mercaptoethanol was then begun. For this purpose, the first 5% by weight of the mixture were added all at once and, after 15 minutes, the remainder was added continuously over a period of 6 hours. Simultaneously with the first addition of the mixture, the continuous addition of a solution of 3.5 g of tert-butyl perpivalate in 60 g of isopropanol was begun and the addition was carried out over a period of 7 hours. The temperature was kept at 80° C. Thereafter, a further 1.4 g of tert-butyl perpivalate in 8 g of isopropanol were added and stirring was then effected for a further 2 hours at 80° C.

Thereafter, heating was effected to 100° C. and a steam distillation was carried out over 1 hour.

A solution of graft copolymer 2 having a solids content of 47.7% by weight and a K value of 27.7, determined as above, was obtained.

### 2. Testing of Performance Characteristics

General Remark:

Polymer V 1 is an acrylic acid/acrylamide copolymer having a K value determined according to Fikentscher of 70, a comonomer ratio in mol % of 90:10 (acrylic acid/acrylamide).

Polymer V 2 is an acrylic acid/acrylamide copolymer having a comonomer ratio in mol % of 85:15 (acrylic acid/acrylamide) and a Fikentscher K value of 25.

2.1. Production of Upper Leather

Two commercial cattle wet blues (from Packer, USA) were shaved to a thickness of 1.8-2.0 mm and cut into eight strips of about 1 000 g each. 2% by weight of sodium formate and 0.4% by weight of NaHCO₃ and 1 % by weight of a naphthalenesulfonic acid/formaldehyde condensate, prepared according to U.S. Pat. No. 5,186,846, example “Dispersant 1”, were then added to the strips in a drum (50 I) and at a liquor length of 200% by weight with an interval of 10 minutes. After 90 minutes, the liquor was discharged. The strips were then distributed over separate tumbling drums.

Together with 100% by weight of water, 1% by weight of a 50% by weight (solids content) aqueous solution of dyes were then metered into each of the drums 1 to 4 at 25-35° C., the solids of said solutions having the following composition:

70 parts by weight of dye from EP-B 0 970 148, example 2.18, 30 parts by weight of Acid Brown 75 (iron complex), Color Index 1.7.16; and tumbling was effected in the drum for 10 minutes.

In a corresponding manner, tanning drums 5 to 8 were each provided with 100% by weight of water and each provided with 1% by weight of a 50% by weight aqueous solution of the dye from DE-A 197 40 473, example 4.3.

Thereafter, as shown in table 1, 4% by weight of each retanning agent according to table 1, followed by 4% by weight of sulfone tanning agent from example K1 of EP-B 0 459 168, and 2% of resin tanning agent Relugan® DLF, both commercially available from BASF Aktiengesellschaft, were added. The strips were then tumbled for 45 minutes at 15 revolutions per minute in the drum. 3% by weight of vegetable tanning agent Mimosa® were then added. After 30 minutes, a further 2% by weight of the respective dye were metered in.

Acidification was then effected with formic acid to a pH of 3.6-3.8. After 20 minutes, the liquors were assessed by an optical method with regard to the exhaustion and were discharged. The leathers were then washed with 200% by weight of water. Finally, 5% by weight of Lipodermlicker® CMG and 2% by weight of Lipodermlicker® PN were metered into 100% by weight of water at 50° C. After a drumming time of 45 minutes, acidification was effected with 1% by weight of formic acid.

The washed leathers were dried, staked, and assessed according to the test criteria specified in table 3. The assessment was effected according to a rating system from 1 (very good) to 5 (poor).

TABLE 1
Performance characteristics of the novel leathers 2.1.3, 2.1.4, 2.1.7 and
2.1.8 and of the comparative leathers V 2.1.1, V 2.1.2, V2.1.5 and V2.1.6.

| | | | Leather properties | | | | | | |
|---|---|---|---|---|---|---|---|---|---|
| | | | | | Color | Dye | | | Miscellaneous |
| Experiment | | Re-tanning | | | intensity | penetration | Levelness of | Grain | Liquor |
| No. | Drum | agent | Body | Softness | (dyeing) | (section) | dyeing | tightness | exhaustion |
| V2.1.1 | 1 | V1 | 3 | 2 | 3 | 4 | 3 | 3.5 | 4 |
| V2.1.2 | 2 | V2 | 2 | 3 | 2 | 3 | 2.5 | 2 | 3 |
| 2.1.3 | 3 | P1 | 1.5 | 2 | 2 | 2 | 2 | 2 | 2.5 |
| 2.1.4 | 4 | P2 | 2.5 | 1.5 | 1 | 2 | 1.5 | 2.5 | 2 |
| V2.1.5 | 5 | V1 | 2.5 | 2 | 3.5 | 3 | 3.5 | 4 | 4 |
| V2.1.6 | 6 | V2 | 2 | 2.5 | 2.5 | 2 | 2 | 2.5 | 2.5 |
| 2.1.7 | 7 | P1 | 2 | 2 | 2 | 1.5 | 1.5 | 2.5 | 1.5 |
| 2.1.8 | 8 | P2 | 2 | 2.5 | 1.5 | 1.5 | 1 | 2 | 2 |

1.2 Chromium-free Production of Furniture Leather

A southern German cattle hide was converted into a wet white semifinished product using (based on the pickled pelt) 1.25% by weight of glutaraldehyde and 3% by weight of the sulfone tanning agent from EP-B 0 459 168, example K1. After the pretanning, the pH was 3.9. After samming, the semifinished products were shaved to a thickness of 1.2 mm and cut into strips of about 350 g each.

In separate drums, the strips were drummed with 100% by weight of water, 6% by weight of sulfone tanning agent from EP-B 0 459 168, example K1 (BASF Aktiengesellschaft), 4% by weight of the vegetable tanning agent Tara®) (BASF Aktiengesellschaft), resin tanning agent 2.5% Relugan S®) (BASF Aktiengesellschaft) and 1.5% by weight of dye for 60 minutes at 25° C.-30° C. at 10 revolutions per minute.

The following dyes were used.

In drums 1 to 4, dye according to example 5.20 from WO 98/41581 was used; in drums 5 to 8, dye according to example 4.18 from EP-B1 0 970 148 was used.

Thereafter, the pH was brought to 3.6 with formic acid and the liquor was discharged after 20 minutes. 5% by weight in each case of retanning agent according to table 2, followed by 6% by weight in each case of the commercial fatliquoring agent Lipodermlicker® CMG from BASF Aktiengesellschaft, 1% by weight of Lipamin® OK and a further 1.5% by weight of the respective dye were metered into the fresh liquor (100% by weight). After a drumming time of a further 60 minutes, the pH was brought to 3.2 with formic acid, samples of the liquor were taken and the liquor discharged. The leathers were washed twice with 100% of water each time, stored moist overnight, sammed and then dried on a toggle frame at 50° C. After staking, the leathers were assessed as below.

The assessment was effected according to a rating system from 1 (very good) to 6 (inadequate). The assessment of the liquor exhaustion was effected visually according to the criteria of residual dye (extinction) and turbidity.

TABLE 2
Performance characteristics of the novel leathers 2.2.3, 2.2.4, 2.2.7 and
2.2.8 and of the comparative leathers V 2.2.1. V 2.2.2, V2.2.5 and V2.2.6.

| | | | Leather properties | | | | | | |
|---|---|---|---|---|---|---|---|---|---|
| | | | | | | Color | | Dye | Miscellaneous |
| Experiment | | Re-tanning | | | Grain | intensity | Levelness of | penetration | Liquor |
| No. | Drum | agent | Body | Softness | tightness | (dyeing) | dyeing | (section) | exhaustion |
| V2.2.1 | 1 | V1 | 4 | 2.5 | 4 | 3 | 3 | 4 | 4 |
| V2.2.2 | 2 | V2 | 3 | 4 | 2 | 2 | 3 | 2.5 | 3 |
| 2.2.3 | 3 | P1 | 3 | 3 | 2 | 1 | 2 | 1.5 | 2 |
| 2.2.4 | 4 | P2 | 2.5 | 2 | 2.5 | 1 | 1.5 | 2 | 2 |
| V2.2.5 | 5 | V1 | 3 | 3 | 4 | 3.5 | 4 | 3 | 4 |
| V2.2.6 | 6 | V2 | 3 | 4.5 | 2.5 | 2 | 3 | 2 | 2.5 |
| 2.2.7 | 7 | P1 | 2 | 3.5 | 2 | 1 | 1.5 | 1.5 | 1.5 |
| 2.2.8 | 8 | P2 | 2 | 2.5 | 2 | 1.5 | 1 | 1.5 | 2 |

The furniture leathers produced according to the invention have outstanding body and a very tight grain with excellent dye dispersion and fixing. Furthermore, it was observed that, by means of the novel retanning process, tanning assistants were more uniformly distributed in the leather and the exhaustion was improved, and the tanning assistants available, in particular the dyes, were thus better utilized. Moreover, the wastewater pollution was correspondingly reduced.

1. A method for the production of leather which comprises utilizing an assistant for leather production wherein the assistant comprises a graft copolymer comprising at least one monoethylenically unsaturated monomer which is incorporated in the form of polymerized units and comprises at least one nitrogen-containing heterocycle.

2. The method according to claim 1, wherein the graft copolymer comprises at least two different monomers which are incorporated in the form of polymerized units and in each case comprise at least one nitrogen-containing heterocycle.

3. The method according to claim 1, wherein the graft copolymer comprises at least one monomer B1 and one monomer B2 incorporated in the form of polymerized units.

4. The use method according to claim 1, wherein the graft copolymer is composed of
a polymeric grafting base A which has no monoethylenically unsaturated units, and
polymeric side chains B formed from copolymers of at least one monoethylenically unsaturated monomer selected from B1 and B2 or monomers B1 and B2 and, optionally, B3, which in each case contain at least one nitrogen-containing heterocycle, and optionally further comonomers B3.

5. The method according to claim 4, wherein the amount of the side chains B on the graft copolymer is greater than 35% by weight.

6. The method according to any of claim 4, wherein the polymeric grafting base A is a polyether.

7. A process for the production of leather utilizing at least one assistant for leather production, wherein the at least one assistant for leather production comprises at least one graft copolymer which comprises at least two monoethylenically unsaturated monomers incorporated in the form of polymerized units, comprising at least one nitrogen-containing heterocycle.

8. The process according to claim 7, wherein the graft copolymers comprises at least one monomer B1 and at least one monomer B2 incorporated in the form of polymerized units.

9. A leather produced according to the process as claimed in claim 7.
